(19) United States
(12) Patent Application Publication
(10) Pub. No.: US 2026/0201689 A1
(43) Pub. Date: Jul. 16, 2026

(54) DRAINPIPE FOR DRAINING WASTE FROM A RECREATIONAL VEHICLE

(71) Applicant: Clint Dickens, Vallejo, CA (US)

(72) Inventor: Clint Dickens, Vallejo, CA (US)

(21) Appl. No.: 19/022,023

(22) Filed: Jan. 15, 2025

(51) Int. Cl. F16L 9/133; B60R 15/00

(52) U.S. Cl. CPC E03F 1/008; B60R 15/00; F16K 3/03

(57) ABSTRACT

A drain apparatus for draining waste from a recreational vehicle into a deposit tank includes a waste transfer tube which is elongated between a first end and a second end. A tank connector is coupled to the first end of the waste transfer tube and is configured to couple to a tank outlet of a sewage tank of the recreational vehicle. A first valve and a second valve are coupled to the waste transfer tube with the first valve positioned between the first end of the waste transfer tube and the second valve. Each of the first valve and the second valve is movable between an open position and a closed position.

### (B) CROSS-REFERENCE TO RELATED APPLICATIONS

Not Applicable

### (C) STATEMENT REGARDING FEDERALLY SPONSORED RESEARCH OR DEVELOPMENT

Not Applicable

### (D) THE NAMES OF THE PARTIES TO A JOINT RESEARCH AGREEMENT

Not Applicable

### (E) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (F) STATEMENT REGARDING PRIOR DISCLOSURES BY THE INVENTOR OR JOINT INVENTOR

Not Applicable

### (G) BACKGROUND OF THE INVENTION

### (1) Field of the Invention

The disclosure relates to drainpipes and more particularly pertains to a new drainpipe for draining waste from a recreational vehicle into a deposit tank.

### (2) Description of Related Art Including Information Disclosed Under 37 CFR 1.97 and 1.98.

The prior art describes various apparatuses for draining waste from a recreational vehicle into a deposit tank. However, the prior art fails to describe such an apparatus in which a flexible inner tube is reinforce by a rigid outer tube and a pair of iris valves are used to prevent spills.

### (H) BRIEF SUMMARY OF THE INVENTION

An embodiment of the disclosure meets the needs presented above by generally comprising a waste transfer tube which is elongated between a first end and a second end. A tank connector is coupled to the first end of the waste transfer tube and is configured to couple to a tank outlet of a sewage tank of a recreational vehicle. A first valve and a second valve are coupled to the waste transfer tube with the first valve positioned between the first end of the waste transfer tube and the second valve. Each of the first valve and the second valve is movable between an open position and a closed position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (I) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a drain apparatus according to an embodiment of the disclosure.

FIG. 2 is an exploded view of an embodiment of the disclosure.

FIG. 3 is a side view of an embodiment of the disclosure.

FIG. 4 is a cross-sectional view of an embodiment of the disclosure taken from Line 4-4 in FIG. 5.

FIG. 5 is an end view of an embodiment of the disclosure in which a first valve is in a closed position.

FIG. 6 is an end view of an embodiment of the disclosure in which a first valve is positioned between a closed position and an open position.

FIG. 7 is an end view of an embodiment of the disclosure in which a first valve is in an open position.

FIG. 8 is an in-use view of an embodiment of the disclosure.

### (J) DETAILED DESCRIPTION OF THE INVENTION

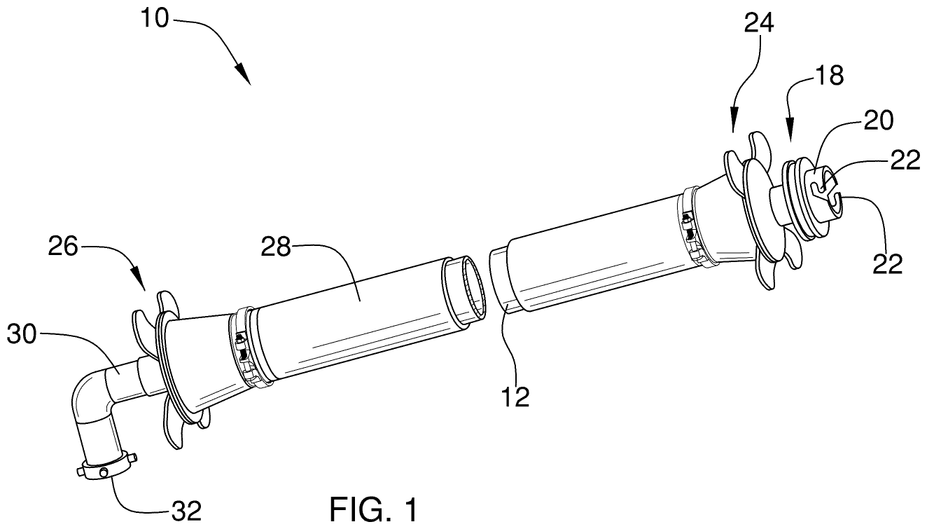

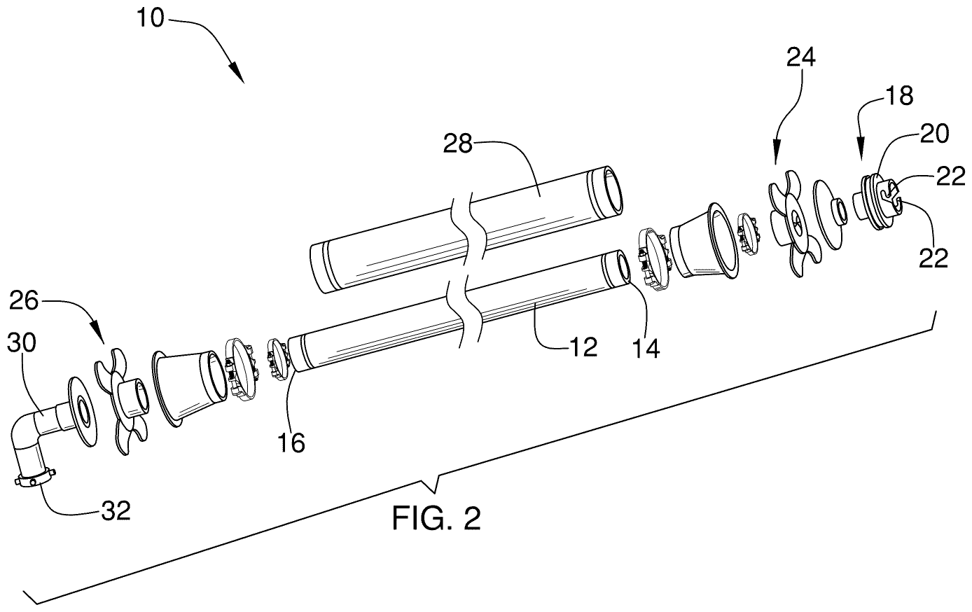

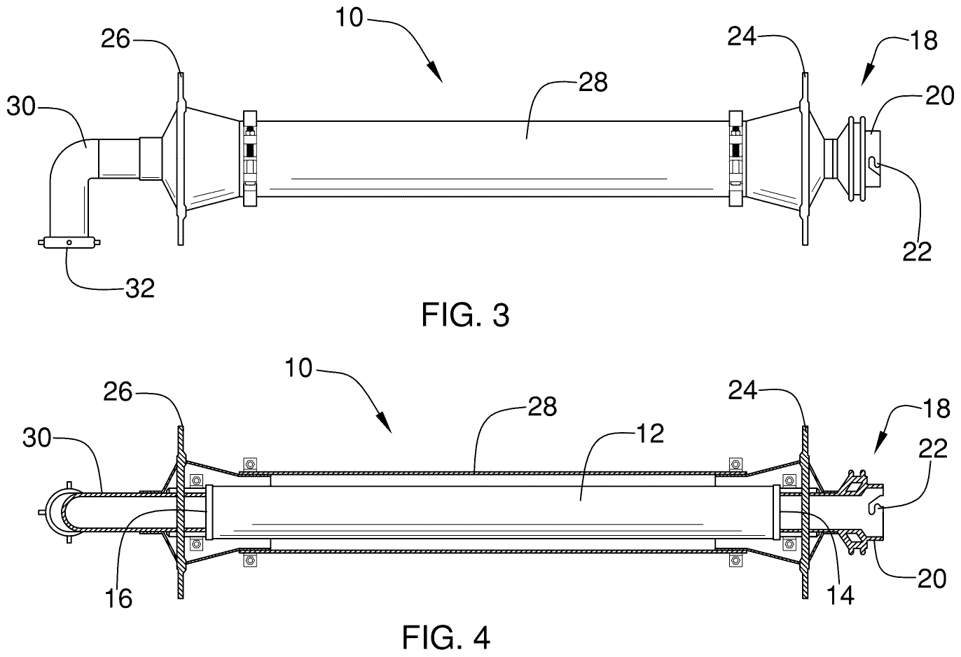

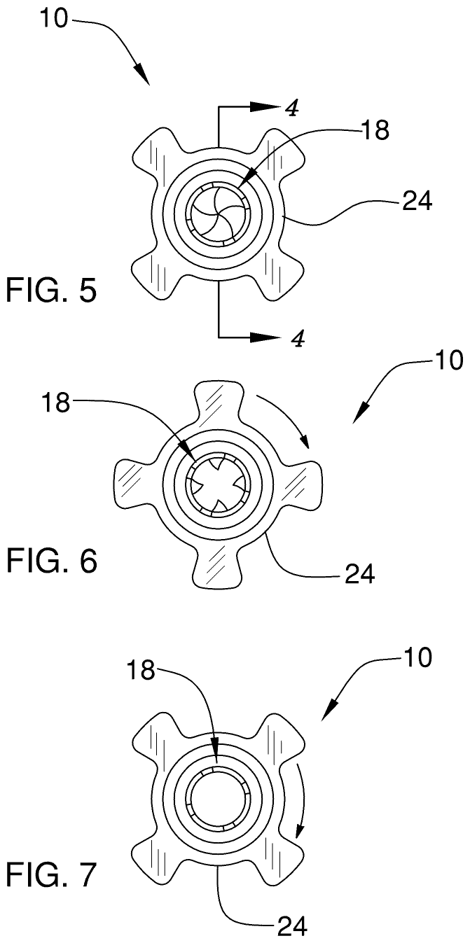

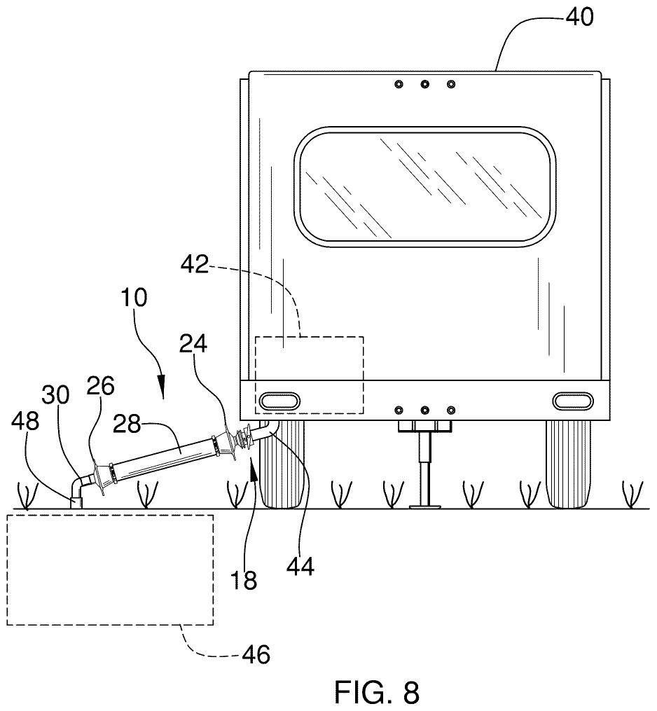

With reference now to the drawings, and in particular to FIGS. 1 through 8 thereof, a new drainpipe embodying the principles and concepts of an embodiment of the disclosure and generally designated by the reference numeral 10 will be described.

As best illustrated in FIGS. 1 through 8, the drain apparatus 10 generally comprises a waste transfer tube 12 which is elongated between a first end 14 and a second end 16. The waste transfer tube 12 comprises a flexible material which may include polyvinyl chloride or another suitable plastic or other suitable material. A tank connector 18 is coupled to the first end 14 of the waste transfer tube 12. The tank connector 18 comprises a twist connect 20 wherein the tank connector 18 is configured to removably couple to a tank outlet 44 of a sewage tank 42 of a recreational vehicle 40. The twist connect 20 comprises hooks 22 which are spaced radially from each other. The twist connect 20 connects to the tank outlet 44 by rotating the hooks 22 into engagement with complementary protrusions that are mounted on the tank outlet 44. In other embodiments, a threaded fastener, a clamp, or another suitable fastener may be used.

A first valve 24 and a second valve 26 are coupled to the waste transfer tube 12. The first valve 24 is positioned adjacent to the first end 14 of the waste transfer tube 12, and the second valve 26 is positioned adjacent to the second end 16 of the waste transfer tube 12. Each of the first valve 24 and the second valve 26 is movable between an open position and a closed position. Each of the first valve 24 and the second valve 26 comprises an iris valve but may comprise another suitable type of valve.

A reinforcement tube 28 is coupled to and surrounds the waste transfer tube 12. The reinforcement tube 28 comprises a rigid material which may include, for example, polyvinyl chloride and an aramid material. The aramid material may be braided around the polyvinyl chloride, for example. Other rigid materials also may be used, such as a rigid plastic, a metal, or the like. An outlet pipe 30 is coupled to the second end 16 of the waste transfer tube 12. The outlet pipe 30 has an L-shape such that an open end 32 of the outlet pipe 30 may be inserted into an inlet 48 for a deposit tank 46 when the waste transfer tube 12 is oriented at an angle to the horizontal of less than 45.0 degrees.

In use, the tank connector 18 is coupled to the tank outlet 44 of the sewage tank 42 and the open end 32 of the outlet pipe 30 is inserted into the inlet 48 for the deposit tank 46. To empty waste water into the deposit tank 46, the first valve 24 and the second valve 26 are opened, along with any release valve connected to the sewage tank 42. The first valve 24 and the second valve 26 may be closed if the drain apparatus 10 needs to be repositioned in such a way that waste water would otherwise spill out without closing the first valve 24 and the second valve 26. Then at least one of the first valve 24 and the second valve 26 may be reopened to release the trapped waste water. The reinforcement tube 28 protects the waste transfer tube 12 from damage and contains leaks from the waste transfer tube 12 should they occur.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A drain apparatus for use with draining a sewage tank of a recreational vehicle, the drain apparatus comprising:
a waste transfer tube being elongated between a first end and a second end;
a tank connector coupled to the first end of the waste transfer tube, the tank connector being configured to couple to a tank outlet of the sewage tank of the recreational vehicle; and
a first valve and a second valve coupled to the waste transfer tube, the first valve being positioned between the first end of the waste transfer tube and the second valve, each of the first valve and the second valve being movable between an open position and a closed position.

2. The drain apparatus of claim 1:
wherein the waste transfer tube comprises a flexible material; and
further comprising a reinforcement tube coupled to and surrounding the waste transfer tube, the reinforcement tube comprising a rigid material.

3. The drain apparatus of claim 2, wherein the flexible material comprises polyvinyl chloride.

4. The drain apparatus of claim 2, wherein the rigid material comprises polyvinyl chloride and an aramid material.

5. The drain apparatus of claim 1, wherein the tank connector comprises a twist connect.

6. The drain apparatus of claim 1, wherein the first valve is positioned adjacent to the first end of the waste transfer tube, the second valve being positioned adjacent to the second end of the waste transfer tube.

7. The drain apparatus of claim 1, wherein each of the first valve and the second valve comprises an iris valve.

8. The drain apparatus of claim 1, further comprising an outlet pipe coupled to the second end of the waste transfer tube, the outlet pipe having an L-shape.

9. A drain apparatus for use with draining a sewage tank of a recreational vehicle, the drain apparatus comprising:
a waste transfer tube being elongated between a first end and a second end, the waste transfer tube comprising a flexible material, the flexible material comprising polyvinyl chloride;
a tank connector coupled to the first end of the waste transfer tube, the tank connector comprising a twist connect wherein the tank connector is configured to removably couple to a tank outlet of the sewage tank of the recreational vehicle;
a first valve and a second valve coupled to the waste transfer tube, the first valve being positioned adjacent to the first end of the waste transfer tube, the second valve being positioned adjacent to the second end of the waste transfer tube, each of the first valve and the second valve being movable between an open position and a closed position, each of the first valve and the second valve comprising an iris valve;
a reinforcement tube coupled to and surrounding the waste transfer tube, the reinforcement tube comprising a rigid material, the rigid material comprising polyvinyl chloride and an aramid material; and
an outlet pipe coupled to the second end of the waste transfer tube, the outlet pipe having an L-shape.
